(19) United States
(12) Patent Application Publication
(10) Pub. No.: US 2009/0041821 A1
(43) Pub. Date: Feb. 12, 2009

(54) Cleaner for medical probe

(76) Inventor: Jacob Fraden, San Diego, CA (US)

Correspondence Address: Jacob Fraden;Advanced Monitors Corp., Ste. 125, 6215 Ferris Sq., San Diego, CA, 92121, US

(21) Appl. No.: 11/891,013

(22) Filed: Aug. 9, 2007

(51) Int. Cl. A01N 31/00; A01N 25/34; A01N 61/00; A01P 1/00; B65D 85/00

(52) U.S. Cl. 424/414; 206/525; 514/724; 514/789

(57) ABSTRACT

Cleaning of a medical probe is provided by a gel layer deposited on a carrier to form a cleaning element. The gel has a tacky surface and is impregnated with a disinfecting agent. After contacting the patient's body surface, the medical probe surface is cleaned by pressing it against the gel surface. The soiling particles that were carried by the probe will be adhered to a gooey layer. The used cleaning element is discarded after cleaning.

### FIELD OF THE INVENTION

This invention claims the benefit of disclosure in the U.S. Provisional Patent Application No. 60/800,282 filed on May 15, 2006, now abandoned. The present invention relates generally to instrumentation having probes. More specifically, it relates to medical devices that have probes that may come in contact with the patient's body surface.

### DESCRIPTION OF PRIOR ART

Various medical instruments intended for diagnostic and treatment of patients contain probes that during the procedure may come in contact with the patient's external body surface. Examples are infrared and contact thermometers and pulse oximeter probes. When the probe comes in contact with the patient's body surface, the dead cells from stratum corneum, bacteria, viruses, dry blood, etc. may adhere to the probe surface and when used on another patient, or even on the same patient again, will be transferred to a new location and thus contaminate it. The reuse increases a risk of transmitting infection from one patient to another and also may cause contamination or soiling of the probe thus making it inoperable. To mitigate the risk, it is customary to use a probe protector that creates a barrier between the probe and the patient. These barriers are commonly called the probe covers. However, in same instances, a probe cover may not be used as it would alter the probe performance and cause a performance degradation. In these cases, the probe or at least its portion that may contact the patient must be cleaned and preferably disinfected.

Disinfection may involve use of liquids or gels that would remove contaminants from the probe surface and destroy infectious organisms. It may involve the active scrubbing and wiping by an operator. A human factor is often an issue with cleaning. Quality of cleaning and wiping off the residue is important. Cleaning is also a time consuming. Besides, if not handled properly, a container that holds the cleaning compound may be contaminated during the cleaning.

It should be understood that the similar cleaning requirements may exist in non-medical applications, for example in fabrication of semiconductors, and other areas.

Prior art knows several methods of cleaning the probe tips that involved the automatic use of brushes and inorganic cleaners as exemplified by U.S. Pat. No. 5,968,282 issued to Yamasaka or adhesive and abrasive pads as in U.S. Pat. No. 6,908,364 issued to Back et al. and U.S. Pat. No. 7,182,672 issued Tunaboyulu et. al. These methods, however, didn't solve the main problems of cleaning a medical probe, such as prevention of cross-contamination, ease of use and low cost.

Therefore, it is an object of this invention to provide a cleaning system that would reduce effects of a human factor;

Another object of this invention is to provide a device that would prevent reusing a cleaning compound.

And another object of the invention is to provide a method of cleaning of a medical probe that would leave no cleaning residue on the probe surface.

While another object is to provide a dispenser of the disposable cleaning elements.

### BRIEF DESCRIPTION OF DRAWINGS

FIG. 1 shows a medical device contacting a body surface;

FIG. 2 illustrates gel patches deposited on a tape;

FIG. 3 is a cross-sectional view of the gel patch deposited on a carrier;

FIG. 4 shows a medical probe pressed against the gel patch;

FIG. 5 is a cross-sectional view of the dispenser;

FIG. 6 shows a portion of a tape consisting of disposable elements;

FIG. 7 illustrates a carrier with multiple gel patches;

FIG. 8 illustrates a carrier with a single large gel patch;

FIG. 9 shows a stack of cleaning elements;

FIG. 10 depicts peeling off a cleaning element for the probe tip.

### DETAILED DESCRIPTION OF PREFERRED EMBODIMENT

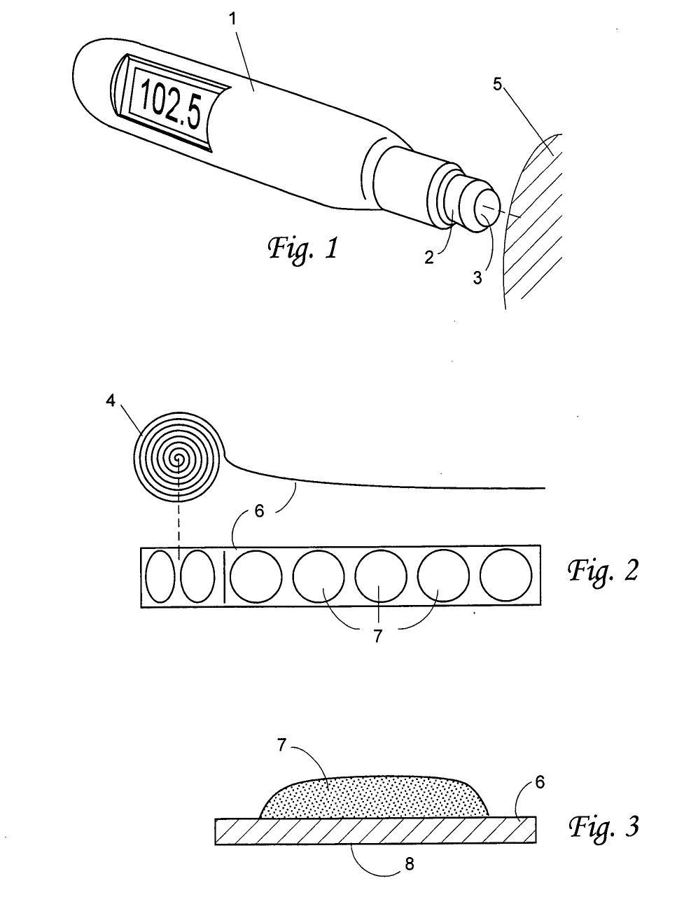

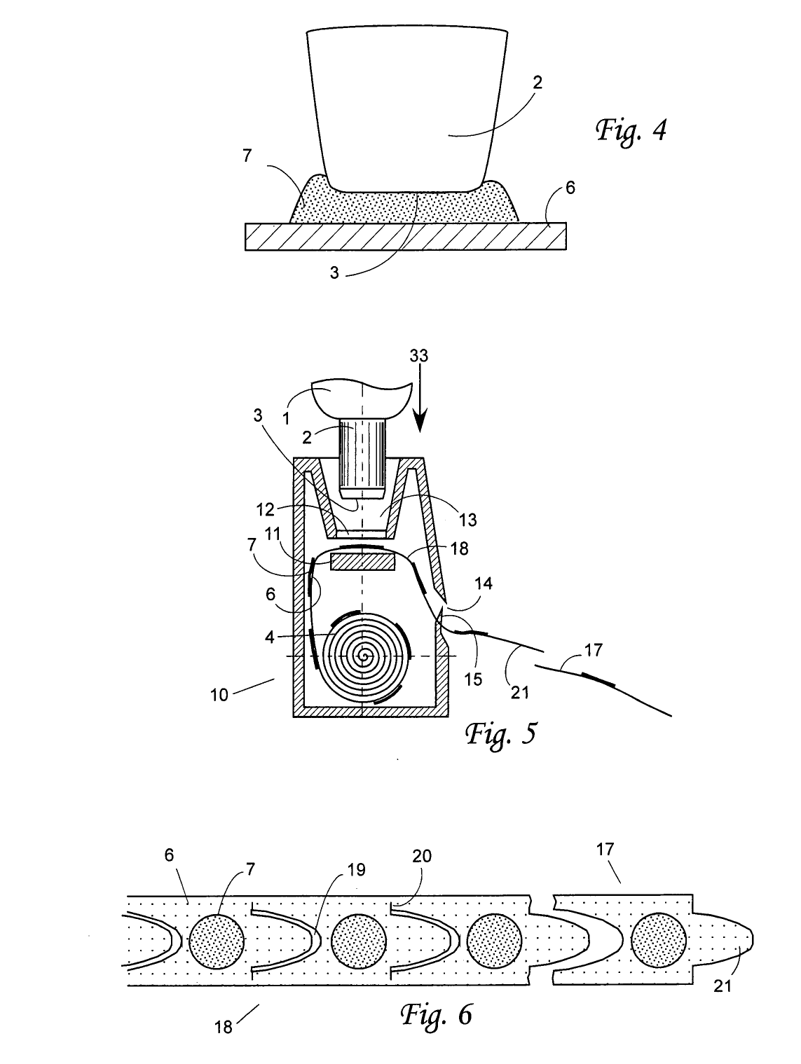

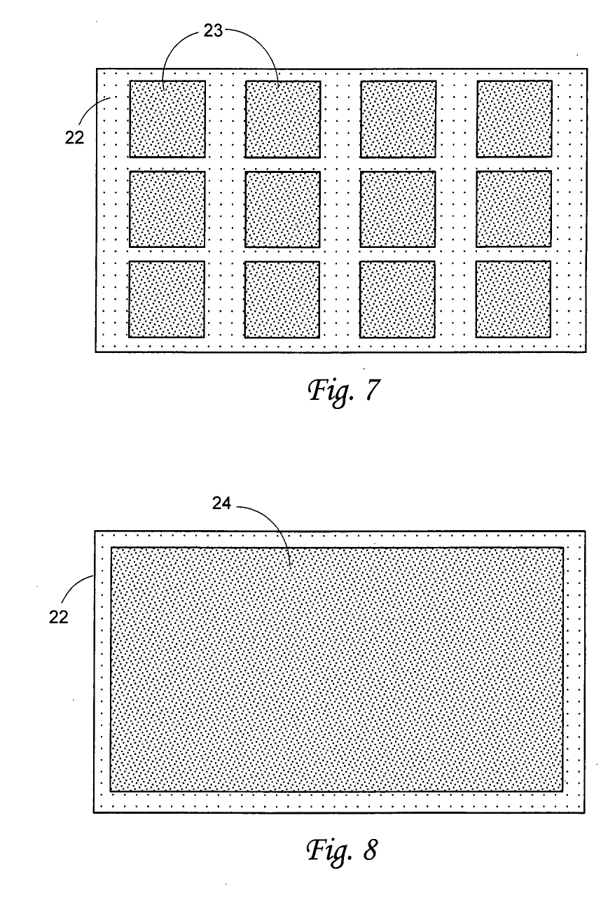

As an illustration of a medical probe that needs cleaning, FIG. 1 shows a contact skin thermometer 1 with a probe 2 having a sensing tip 3. For measuring the skin temperature, the sensing tip 3 of the probe 2 comes in contact with the patient body 5. Instead of a thermometer, other medical probes may be used in a similar manner. When tip 3 touches the patient skin, it may pick up some bacteria, skin particles and other soiling and contaminating compounds. If subsequently used on another patient or even on the same patient, these contaminants may be transferred by the tip 3 to a new location and cause adverse affect, such as deposition of bacteria, e.g. To remove the soiling compound from the surface of the tip 3 after each use, a cleaning agent may be employed. In this embodiment, the cleaning agent is a low-tack adhesive or gel that is deposited in form of a gooey patch 7 on a carrier 6 as illustrated in FIGS. 2 and 3. FIG. 2 shows a carrier 6 in form of a tape. The carrier 6 may be fabricated of a paper or polymer film having a thickness between 0.002 and 0.020″. The patch 7 may have a thickness 0.010″ or larger. The adhesive or gel may be water based, containing at least 20% of water, or silicone based. An example of a gelling agent is ethyl(hydroxyethyl)cellulose, hydroxypropylcellulose. The adhesive or gel may be impregnated with various fillers serving different purposes. One type of a filler is dye to give the patch 7 a specific color. Another type of a filler is a disinfecting agent. Examples of the disinfectants for use in this application are quaternary ammonium compounds, phenolic compounds and alcohols. To prevent the water based adhesive or gel from drying out or losing the fillers, the patch 7 surface may be covered with a protective film layer (that shall be removed before the use) or the tape may be rolled into a drum or roll 4 as shown in FIG. 2. The gel patches may be formed in any suitable shape, such as disks as shown in FIG. 4, rectangulars 23 on a larger base sheet 22 as shown in FIG. 7 or as a continuous large layer 24 as in FIG. 8. The back side 8 (FIG. 3) of carrier 6 preferably should have low adherence to the gooey patch 7 so when rolled up or stacked and then opened or separated, the patch 7 will remain only on one side of the carrier 6.

After the probe 2 has been used (contacted the patient skin, e.g.) it is cleaned by being pressed against the surface of the patch 7 as shown in FIG. 4. The tip 3 of the probe 2 impinges into the body of the patch 7 making an intimate contact with its mass. Since the adhesive or gel is tacky, the soiling particles (contaminants) that were carried by probe 2 will stick and transfer to the patch 7 and remain there after probe 2 is removed. Small portions of the disinfecting agent will be released from the patch 7 to the tip 3 of the probe 2 and destroy bacteria or viruses if such still remain on the tip. The disinfectant will also de-contaminate the used soiled patch 7 so it will not become a depot of infection.

To facilitate ease of use, the cleaning elements containing patches 7 may be dispensed, for example, from a tape carrier 6 rolled up into a drum 4 as shown in FIG. 5. The patches are positioned on the outside surface of the tape 18, thus each disinfecting element is joined together with a neighboring disinfecting cleaning element, forming a chain where each element can be sequentially detached from the chain. The dispenser 10 contains the opening 12 inside the cleaning well 13 that allows the probe 2 to be inserted into the dispenser and aligned with the cleaning pad. When moved in direction 33, the tip 3 touches the patch 7 of the tape 18 to compress it against the rest 11 so that the patch 7 is in tight contact with the probe 2 and the patch 7 can disinfect the tip 3. The tape may have perforations on it sides, as in a photographic film, or be formed with the separate sections (elements) as shown in FIG. 6. Each section 17 may be removed one by one and torn off from the tape 18 along the breakaway lines 20. The tape has cutouts 19 which form tabs 21. When inside the holding chamber of the dispenser 10, the cutout 19 is retained by the tooth 15 in the slot 14 (FIG. 5). The tooth and slot form a separator of the elements (sections) of the tape 18. After cleaning of the tip 3 and using one element of the tape 18, the tab 21 is pooled out by the operator (the tooth 15 holds the remaining tape inside the housing of the dispenser) and the used cleaning element is separated from the rest of the tape 18. The used torn off element 17 is discarded. Note that after removal of the used element, a fresh patch is aligned with the probe 2 for the next compression against the rest 11. Each cleaning element is used only once and discarded.

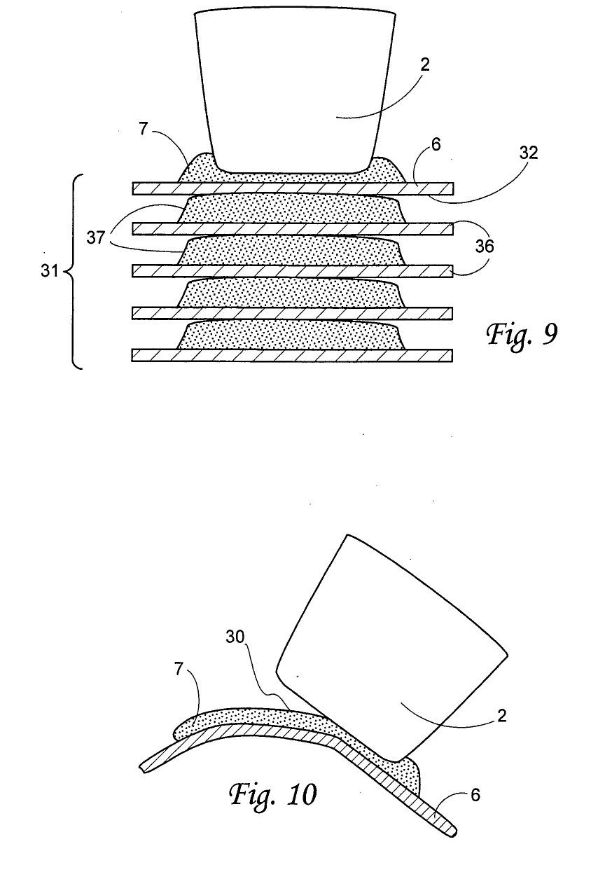

The disinfecting patches 23 or layer 24 may be formed on a flat sheet of carrier 22, as illustrated in FIGS. 7 and 8. They my be used alone or inside another type of a dispenser whose design would be rather trivial and thus is not described here. The individual cleaning elements may be organized in a stack 31 as in FIG. 9, where tacky patches 37 are separated from one another by the carriers 36. The probe 2 is pressed against the upper patch 7 and then removed from the stack together with the entire element thanks to a sticky effect of the patch. After that, the element may be peeled off as shown in FIG. 10, thus holding the contaminants on the spot 30 of the patch 7 and leaving the probe 2 clean.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A disinfecting element for cleaning a surface of the probe external surface, being comprised of
a carrier;
the upper layer being disposed on a surface of said carrier;
a filler, being impregnated into the volume of said upper layer.

2. A disinfecting element of claim 1 wherein said upper layer is a low-tack adhesive.

3. A disinfecting element of claim 1 wherein said upper layer is gel.

4. A disinfecting element of claim 1 wherein said filler is a disinfecting agent;

5. A disinfecting element of claim 1 wherein said filler is a dye;

6. A disinfecting element of claim 1 wherein said carrier is a flexible film fabricated of paper or polymer, having thickness between 0.002 and 0.020″.

7. A disinfecting element of claim 4 wherein said disinfecting agent is alcohol.

8. Method of cleaning the surface of a probe by a cleaning element, comprising the steps of
forming a cleaning element by disposing the upper layer on the surface of a flexible carrier;
impregnating the upper layer with disinfecting agent;
pressing surface of the probe onto the surface of the upper layer;
removing the probe from said upper layer.

9. A dispenser for bringing together the outer surface of a probe and the cleaning element, being comprised of
a dispenser housing;
a holding chamber, being part of said dispenser housing, to hold the multitude of cleaning elements;
a cleaning well to align said probe with a cleaning element;

10. A dispenser of claim 9 further comprising a separator to detach said cleaning element from another cleaning element.

11. A disinfecting element of claim 1 where said carrier is attached to another carrier of an identical disinfecting element to form a chain comprised of at least two joined disinfecting elements;
